(19) United States
(12) Patent Application Publication
(10) Pub. No.: US 2019/0172276 A1
(43) Pub. Date: Jun. 6, 2019

(54) VEHICLE ENVIRONMENTAL COMPLIANCE SYSTEM AND METHOD

(71) Applicant: NEXUS ENVIRONMENTAL, LLC, Miami Beach, FL (US)

(72) Inventor: Pradeep R. Tripathi, Miami Beach, FL (US)

(21) Appl. No.: 16/212,220

(22) Filed: Dec. 6, 2018

Related U.S. Application Data
(60) Provisional application No. 62/595,361, filed on Dec. 6, 2017.

(51) Int. Cl. G07C 5/08; F01N 11/00; G07C 5/00

(52) U.S. Cl. CPC G07C 5/0808; G07C 5/008; F01N 11/007

(57) ABSTRACT

A vehicle environmental compliance system includes: an onboard diagnostic (“OBD”) tool configured to obtain OBD data from a vehicle's onboard diagnostics; an application for storage on a mobile computing device in communication with the OBD tool, the application configured to process the OBD data to form processed OBD data; a compliance center or server for receiving the process the OBD data from the application, the compliance center or server configured to further process the processed OBD data to form further processed OBD data; and wherein one of the processed OBD data or the further processed OBD data includes a result of OBD data subjected to a compliance evaluation routine, and wherein the system maintains a triggering algorithm that determines when the compliance evaluation routine is performed.

### PRIORITY CLAIM

This application claims priority to and the benefit as a non-provisional application to U.S. Provisional Application No. 62/595,361, filed Dec. 6, 2017, entitled Vehicle Environmental Inspection System and Method, the entire contents of which are incorporated herein by reference and relied upon.

### BACKGROUND OF THE DISCLOSURE

The present invention is directed to a method and system for determining compliance of a vehicle with exhaust environmental regulations and, in particular, determining compliance using remote onboard diagnostics (“OBD”).

Most states require determination that each vehicle licensed in that state is in compliance with environmental regulations for that state. While compliance can be determined using a probe inserted into the tailpipe of the vehicle, compliance can also be determined for more recent model vehicles from vehicle data developed by the OBD system of the vehicle. Vehicles having an OBD system typically have an OBD terminal, or connector, which can be connected with testing equipment to read vehicle data from the OBD system of the vehicle. Such vehicle data can be used to diagnose problems with the operation of the vehicle. Also, the vehicle data obtained from the OBD system can be used to determine compliance of the vehicle with environmental regulations.

There are two conventional techniques for performing compliance of a vehicle with environmental regulations using OBD produced vehicle data. One technique is to drive the vehicle to a testing center within a time set by state regulations, typically once a year, twice a year, or every two years, for example. The other technique is to interface a remote OBD tool with the OBD connector to collect and distribute OBD data for evaluation.

While OBD data evaluation for vehicle emissions compliance exists, this technology has not been widely adapted. A need exists for an improved OBD vehicle emission evaluation system and method accordingly.

### SUMMARY OF THE DISCLOSURE

The present disclosure is based on a recognition of various reasons why remote OBD is not commercially successful even though it is much more convenient to driving to a test center. In particular, while determining compliance of a vehicle at a test center is carried out periodically, OBD data is generated in a substantially continuous manner. Therefore, the vehicle operator perceives that the vehicle is subjected to a more rigorous testing routine if performed using remote OBD than if done at the test center. Thus, the vehicle operator perceives that remote OBD rather than a test center compliance evaluation is not equitable with compliance testing at a test station.

Another reason why remote OBD is not commercially successful is that a workable solution for transporting the OBD data form the OBD device to a testing location has not been found.

A method of performing remote vehicle environment compliance inspection and a vehicle environmental compliance inspection system, according to an aspect of the invention, includes interfacing a remote OBD tool with a vehicle OBD system. The tool is caused to obtain vehicle data from the vehicle diagnostic system and relay vehicle environmental test data obtained by the OBD tool that is sufficient to determine emission compliance of the vehicle to a mobile computing device, such as a smartphone or tablet. Communication between the OBD tool and the mobile computing device may for example be via Bluetooth.

The mobile computing device stores an application, which may be a software application or a browser application which receives the data from the OBD device and places the data in a desired format for sending wirelessly, via the wireless network used by the mobile computing device, to a vehicle environmental compliance center or server. The vehicle environmental compliance center or server determines from the test data whether the vehicle is in compliance with vehicle environmental compliance standards according to a testing routine. In the embodiment just described, the stored application does not evaluate the data for compliance purposes. In alternative embodiments, however, the stored application may perform some or all of the compliance evaluation.

The environmental compliance center or server performs whatever compliance evaluation is not performed by the application stored on the mobile computing device. If the mobile computing device application performs none of the compliance evaluation, the compliance center or server performs all of the compliance evaluation. If the mobile computing device application performs some of the compliance evaluation, the compliance center or server performs the remainder of the compliance evaluation. If the mobile computing device application performs all of the compliance evaluation, the compliance center or server performs none of the compliance evaluation.

The compliance center or server may be owned and/or controlled by a private organization, which is contracted by a jurisdiction, e.g., state, city or municipality. Here, the private organization communicates the results of the compliance evaluations to a contracting jurisdiction, which handles results as it sees fit. The compliance center or server may be owned and/or controlled alternatively by the jurisdiction itself, e.g., state, city or municipality.

In various embodiments, the compliance evaluations are performed upon a trigger, that is, the compliance evaluations are not performed on a continuous basis, as the OBD device continuously collects data form the vehicle. It is contemplated that the trigger may be based upon different factors and/or combinations of factors. One factor is duration from the previous compliance evaluation, e.g., an evaluation is to be performed every year or two years. Another factor is mileage, e.g., an evaluation is to be performed every 20,000 miles. A further factor is make of automobile, e.g., larger automobiles are tested more often than smaller ones. Yet another factor is year of manufacturer, e.g., older automobiles are tested more often than newer ones. Still a further factor is performance based, e.g., automobiles obtaining better miles per gallon are tested more often than automobiles having worse gas efficiency. Still another factor is internal and/or external sensing based, e.g., based upon internal catalytic convertor temperature or upon outside temperature. Yet a further factor is based upon a random number generator. Any one of the above factors may be combined with any one or more of the other factors to yield an overall algorithm for when vehicle environmental testing is to be performed.

In one embodiment, the OBD tool that interfaces with the OBD port or connector of the automobile is not involved with the trigger just described and acquires data at a frequency according to its own programming. There are many OBD tools or links on the market, many of them based upon ELM software and firmware. The system and method of the present disclosure contemplate using one of such devices already on the market. Indeed, there currently exist OBD tools that are capable of interfacing with iOS and Android operating systems, such that they can talk to many mobile computing devices (smartphones, tablets, etc.) currently on the market.

The application stored on the mobile computing device may be involved with the triggers just described to varying degrees. If the compliance evaluations are performed at the compliance center or server, then the triggers may be implemented at the mobile computing device in at least two ways. In a first way, the mobile computing device does not accept data from the OBD tool until the compliance center or server tells it to do so based upon a triggering event. The mobile computing device takes one or more snapshot of data from the OBD tool, processes the data as programmed, and forwards the processed data to the compliance center or server. This first way is advantageous because the OBD tool is not continuously bombarded with unused data.

In a second way, the mobile computing device accepts data as generated by the OBD tool, but does not send any data to the compliance center or server until told to so by the center or server. The second way may be advantageous in that more data can be sent to the compliance center or server, however, memory storage on the mobile computing device may become problematic. A third option is to not apply the trigger to the mobile computing device at all and let all data be sent to the compliance center or server, which uses the data according to the trigger.

If the compliance evaluations are performed at the mobile computing device, then the mobile computing device stores and executes the triggering algorithm. Here, the triggering algorithm in one embodiment tells the mobile computing device when to accept data from the OBD tool. The mobile computing device takes one or more snapshot of the data upon a triggering event, evaluates the data for compliance and sends the results to the compliance center or server, which may further process the results for sending to a jurisdiction for regulatory administration.

In various embodiment, the compliance evaluation routine may be established by computer code residing on the compliance center or server or the mobile computing device. The compliance evaluation routine looks at the vehicle OBD data, which may include any one or more of OBD tool serial number, vehicle identification number, date of data collection, time of data collection, communication protocol, catalyst data, catalyst heater data, evaporator data, air data, oxygen sensor data, oxygen sensor heater data, fuel system data, misfire data, air conditioner data, engine RPM, diagnostic trouble codes, pending diagnostic trouble codes, permanent diagnostic trouble codes, etc. According to the compliance evaluation routine, the data may itself indicate a pass or fail or be compared to an acceptable range or standard to indicate pass or fail. As listed, many evaluations may be made. Overall pass or fail may be determined to be fail if any of the numerous evaluations show fail, or if a certain number show fail, and/or if a particular one or more important evaluation shows fail.

In light of the description herein, it should be appreciated that any one or more aspect described in any claim below may be combined with any one or more other aspect of any one or more other claim below unless stated otherwise. Also, any one or more aspect described in any claim below may be combined with any structure and/or functionality illustrated and described in connection with any one or more figure provided herein.

It should also be appreciated that it is an advantage of the present disclosure to provide a remote OBD vehicle environmental inspection system and method that efficiently moves data form the OBD device to a location in which the data may be evaluated for compliance purposes.

It is another advantage of the present disclosure to provide a remote OBD vehicle environmental inspection system and method that flexibly allows for different triggers to determine when the remote OBD is to be evaluated for compliance purposes.

These and other aspects, advantages and features of this invention will become apparent upon review of the following specification in conjunction with the drawings. It should be appreciated that each embodiment described herein does not have to embody each of the advantages described herein

### BRIEF DESCRIPTION OF THE DRAWINGS

FIG. 1 is a process flow diagram of a method of performing remote vehicle environment compliance according to an embodiment of the invention;

FIG. 2 is a process flow diagram of a method of performing remote vehicle environment compliance according to an alternative embodiment;

FIG. 3 is a process flow diagram of a method of performing remote vehicle environment compliance according to another alternative embodiment; and

FIG. 4 is a block diagram of one embodiment of a remote OBD system that may carry out the methods of FIGS. 1 to 3.

### DETAILED DESCRIPTION OF THE DISCLOSURE

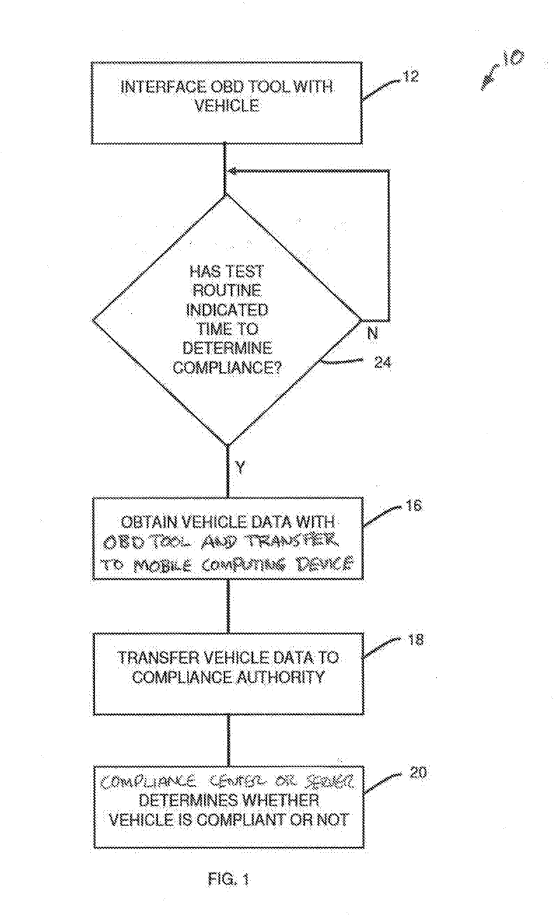

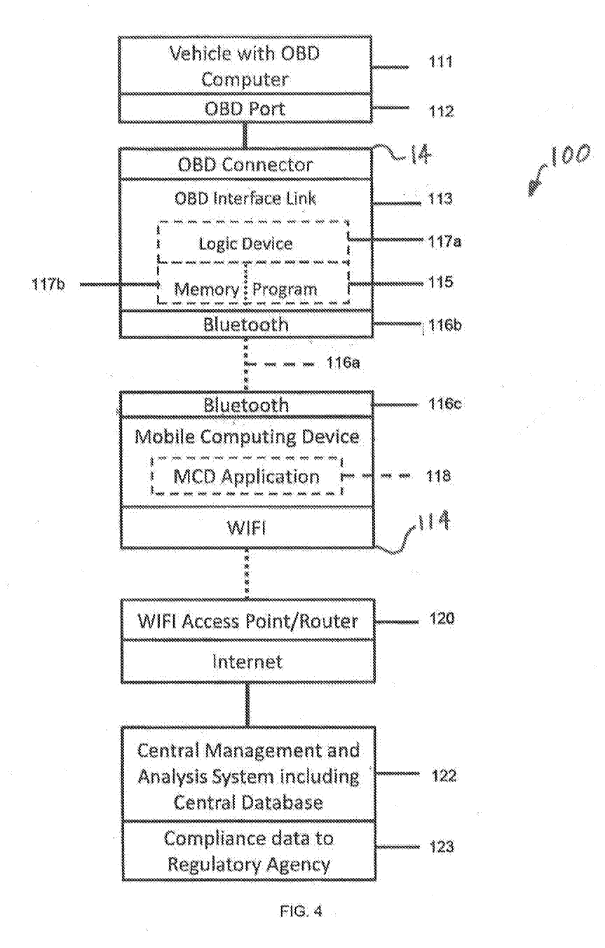

Referring now to the drawings and the illustrative embodiments depicted therein, a method 10 (FIG. 1) for performing remote vehicle environment compliance inspection includes interfacing at block 12 a remote OBD tool 14 (FIG. 4) with a vehicle OBD computer 111 (FIG. 4). The tool 14 is caused at block 16 to obtain vehicle data via a vehicle OBD port 112 (FIG. 4) from the vehicle OBD computer 111 and relay that data to mobile computing device 114 (FIG. 4). In one embodiment the connection between OBD tool 14 and vehicle OBD port 112 is an electrical connection, wherein multiple conductive pins of the OBD tool 14 are inserted into multiple conductive sockets of OBD port 112 or vice versa. In one embodiment, the data connection between OBD tool 14 and mobile computing device 114 is wireless, e.g. via Bluetooth communication.

At block 18, vehicle environmental test data obtained by the OBD tool 14 and sent to mobile computing device 114, wherein such data is sufficient to determine emission compliance of the vehicle, is sent from mobile computing device 114 to a vehicle environmental compliance center or server 122 (FIG. 4). The environmental compliance center or server 122 at block 20 determines from the test data whether the vehicle is in compliance with vehicle environmental compliance standards according to an emissions compliance evaluation routine. The compliance evaluation routine is triggered upon a triggering event as set forth below.

In environmental compliance inspection method 10, the triggering event determination of whether to perform a compliance evaluation routine is performed at diamond 24. If a triggering event has not occurred, then method 10 returns to the input of diamond 24. If a triggering event has occurred, then method 10 proceeds to block 16 where OBD tool 14 obtains vehicle data from the vehicle OBD port 112 and computer 111. As illustrated in FIG. 1, diamond 24 causes method 10 to wait in a loop until a triggering event occurs, then continues to the next process step. The triggering event associated with diamond 24 may be based upon one or more factors. One factor is duration from the previous compliance evaluation, e.g., an evaluation is to be performed every year or two years. Another factor is mileage, e.g., an evaluation is to be performed every 20,000 miles. A further factor is make of automobile, e.g., larger automobiles are tested more often than smaller ones. Yet another factor is year of manufacturer, e.g., older automobiles are tested more often than newer ones. Still a further factor is performance based, e.g., automobiles obtaining better miles per gallon are tested more often than automobiles having worse gas efficiency. Still another factor is internal and/or external sensing based, e.g., based upon internal catalytic convertor temperature or upon outside temperature. Yet a further factor is based upon a random number generator. Any one of the above factors may be combined with any one or more of the other factors to yield an overall algorithm for when vehicle environmental testing is to be performed.

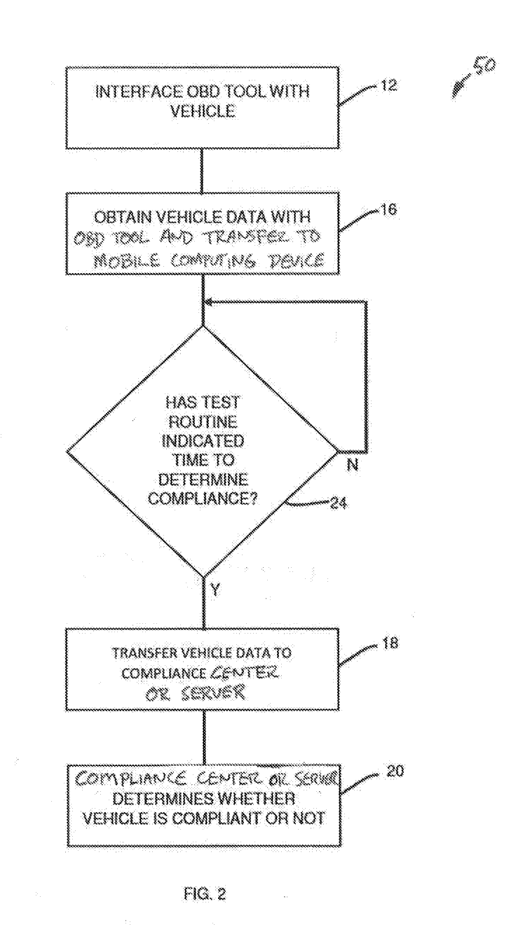

In FIG. 1, OBD data from the vehicle is not sent from OBD tool 14 to mobile computing device 114 until the triggering event has occurred, which is advantageous because data transfer is limited until it is needed, at which time mobile computing device 114 takes one or more snapshot of data from OBD tool 14. FIG. 2 illustrates an alternative method 50 in which the triggering event query at diamond 24 occurs instead after mobile computing device 114 has received data from OBD tool 14 at block 16, but before mobile computing device 114 relays the OBD data to environmental compliance center or server 122 at block 18. Method 50 spares environmental compliance center or server 122 from having to accept unused data, and may send stored packets of data to center or server 122 as opposed to the snapshot(s) taken in connection with method 10. In method 50, however, mobile computing device 114 receives unused data.

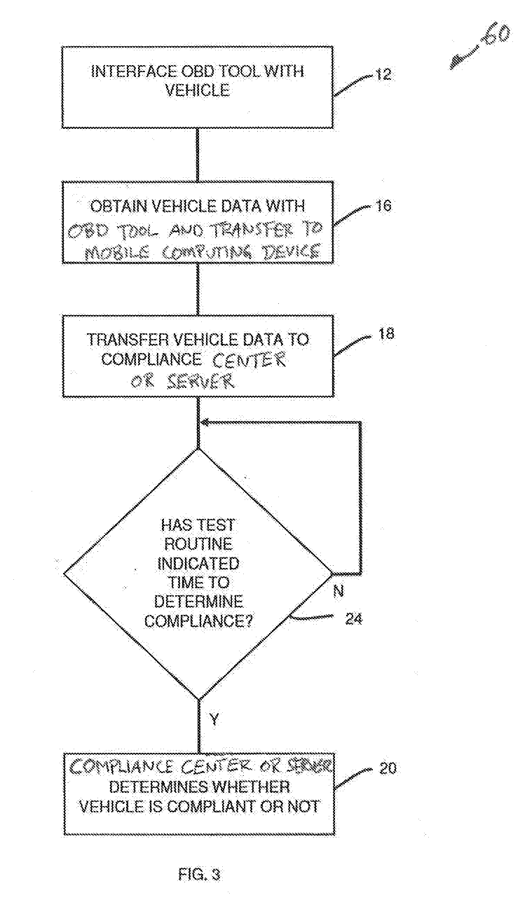

FIG. 3 illustrates another alternative method 60 of performing remote vehicle environment compliance inspection. In method 60, the triggering event query at diamond 24 occurs instead after mobile computing device 114 relays the OBD data to environmental compliance center or server 122 at block 18, but before environmental compliance center or server 122 performs the test center compliance evaluation at block 20. Here, environmental compliance center or server 122 accepts unused data but as an advantage may use as much of the data as desired upon the occurrence of a triggering event.

FIGS. 1 to 3 illustrate where the triggering event query at diamond 24 is applied. The software and processing for knowing and tracking the triggering event in method 10 in FIG. 1 may reside either on mobile computing device 114 or at compliance center or server 122. When residing on mobile computing device 114, the triggering event occurring within its own software tells mobile computing device 114 when to take the snapshot of data from OBD tool 14. When residing instead on compliance center or server 122, compliance center or server 122 tells mobile computing device 114 when to take the snapshot of data from OBD tool 14. The software and processing for knowing and tracking the triggering event in methods 50 and 60 of FIGS. 2 and 3 resides at compliance center or server 122 because the OBD data has already been delivered from mobile computing device 114 to compliance center or server 122.

Similarly, it should be appreciated that in method 10 of FIG. 1, the compliance evaluation routine may be performed at either (i) mobile computing device 114, where the results (e.g., overall pass/fail and underlying evaluations) are forwarded to compliance center or server 122 or (ii) compliance center or server 122. In methods 50 and 60 of FIGS. 2 and 3, the compliance evaluation is performed at compliance center or server 122 because the OBD data has already been delivered from mobile computing device 114 to compliance center or server 122.

Regarding the compliance evaluation routine performed at either computing device 114 or compliance center or server 122, the routine in one embodiment looks at the vehicle OBD data obtained from vehicle OBD system 111 and diagnostic port 112, which may include any one or more of OBD tool serial number, vehicle identification number, date of data collection, time of data collection, communication protocol, catalyst data, catalyst heater data, evaporator data, air data, oxygen sensor data, oxygen sensor heater data, fuel system data, misfire data, air conditioner data, engine RPM, diagnostic trouble codes, pending diagnostic trouble codes, permanent diagnostic trouble codes, etc. According to various embodiments for the compliance evaluation routine, the data may itself indicate a pass or fail or be compared to an acceptable range or standard to indicate pass or fail. As listed, many evaluations may be made. Overall pass or fail may be determined to be fail if any of the numerous evaluations show fail, or if a certain number show fail, and/or if a particular one or more important evaluation shows fail.

Referring now to FIG. 4, OBD tool 14, mobile computing device 114 and compliance center or server 122 are illustrated as being part of a vehicle environmental compliance inspection system 100 that is for use with a vehicle (not shown) equipped with an OBD system 111 and having a diagnostic port 112 for accepting OBD tool 14. System 100 is capable of implementing any of methods 10, 50 and 60. In the illustrated embodiment, OBD tool 114 includes an OBD interface link 113 that is configured to connect with diagnostic port 112 of OBD system 111 and to read emission data from OBD system 111. OBD tool 114 further includes a logic circuit 117a, such as a programmed microprocessor, or the like, memory 117b that stores data, an onboard link application 115, which is configured to read OBD data from vehicle diagnostic port 112 and communicate the OBD data to mobile computing device 114. OBD tool 14 may be an off the shelf device, which may for example be based upon ELM software and firmware. OBD tool 14 in one embodiment is capable of interfacing with iOS and Android operating systems, such that tool 14 can talk to different mobile computing devices 114 (smartphones, tablets, etc.) currently on the market.

Regarding the communication between OBD tool 14 and mobile computing device 114, a communication channel 116a is established between interface device 113 and OBD port 112. Mobile computing device 114 may be a cellular device, e.g., a smart phone, tablet media player, tablet computer, or the like. In the illustrated embodiment, communication channel 116a is a Bluetooth, RFID or other, e.g., short range, wireless communication protocol. OBD tool 14 is illustrated accordingly having a Bluetooth interface 116b, while mobile computing device 114 is illustrated having a Bluetooth interface 116c, which enable wireless Bluetooth communication via channel 116a. Communication channel 116a is configured to communicate the diagnostic data read by the OBD interface link 113 to mobile computing device 114.

Mobile computing device 114 is normally carried by the user and is therefore in range of OBD tool 14 to accept OBD data from OBD tool 14 when called upon. In the illustrated embodiment, mobile computing device 114 stores a mobile computing device (“MCD”) application 118, which may include actual software for processing the OBD data or be a browser application in which the actual software for processing the OBD data is stored in and recalled from a cloud server or other remote server. In either case, application 118 either places the OBD data in a form suitable for use by compliance center or server 122 or performs the compliance evaluation routine and send the results to compliance center or server 122 for further processing to place in a condition suitable for sending to a jurisdiction as discussed above.

Mobile computing device 114 includes a wireless or WIFI interface as illustrated, which communicates wirelessly, e.g., over the internet and via a WIFI access point/router 120, with compliance center or server 122, which in FIG. 4 is illustrated having a central management and analysis system including a central database. The central database enables OBD data and/or results from evaluations of OBD data from multiple OBD tools 14/mobile computing devices 114 to be accepted, further processed and managed in one location. The central management and analysis system may store and execute the triggering algorithm(s) used to determine when each of the constituent vehicles (e.g., of a specific jurisdiction) is to be evaluated as well as the compliance evaluation routine(s) used to determine pass or fail for the constituent vehicles.

OBD tool 14 may alternatively communicate with a wireless communication transceiver that is external the vehicle, and is part of a proprietary network, such as via a two-way wireless communication. The transceiver may either be stationary as disclosed in U.S. Pat. No. 8,428,814 entitled METHOD OF VERIFYING REGULATORY COMPLIANCE OF A VEHICLE HAVING A VEHICLE DIAGNOSTIC SYSTEM, or in another vehicle as disclosed in U.S. Pat. No. 7,596,435 entitled VEHICLE COMMUNICATION SYSTEM AND METHOD WITH MOBILE DATA COLLECTION, the disclosures of which are hereby incorporated herein by reference in their entirety. Other communication protocol would be apparent to the skilled artisan.

Compliance center or server 122 may be owned and/or controlled by a private organization, which is contracted by a jurisdiction 123, e.g., state, city or municipality. Here, the private organization communicates the results of the compliance evaluations to a contracting jurisdiction 123, which handles results as it sees fit. Compliance center or server 122 may be owned and/or controlled alternatively by jurisdiction 123 itself, e.g., state, city or municipality. Either way, jurisdiction 123 ultimately receives compliance data as illustrated in FIG. 4, so that it may respond to non-compliant vehicles as needed.

While the foregoing description describes several embodiments of the present invention, it will be understood by those skilled in the art that variations and modifications to these embodiments may be made without departing from the spirit and scope of the invention, as defined in the claims below. For example, in method 10, computing device 114 may be configured to take multiple snapshots of OBD data from OBD tool 14 and average or otherwise process the OBD data snapshots as desired. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A vehicle environmental compliance system comprising:
an onboard diagnostic (“OBD”) tool configured to obtain OBD data from a vehicle's onboard diagnostics;
an application for storage on a mobile computing device in communication with the OBD tool, the application configured to process the OBD data to form processed OBD data;
a compliance center or server for receiving the processed OBD data, the compliance center or server configured to further process the processed OBD data to form further processed OBD data; and
wherein one of the processed OBD data or the further processed OBD data includes a result of OBD data subjected to a compliance evaluation routine, and wherein the system maintains a triggering algorithm that determines when the compliance evaluation routine is performed.

2. The vehicle environmental compliance system of claim 1, wherein the processed OBD data via the application includes the result of OBD data subjected to the compliance evaluation routine.

3. The vehicle environmental compliance system of claim 2, wherein the further processed data from the compliance center or server includes the result of OBD data subjected to the compliance evaluation routine placed into a form suitable for sending to a jurisdiction.

4. The vehicle environmental compliance system of claim 1, wherein the further processed OBD data via the compliance center or server includes the result of OBD data subjected to the compliance evaluation routine.

5. The vehicle environmental compliance system of claim 4, wherein the processed OBD data via the application includes OBD data from the OBD tool placed into a form suitable for sending to the compliance center or server.

6. The vehicle environmental compliance system of claim 1, wherein the compliance evaluation routine is stored and processed at the application.

7. The vehicle environmental compliance system of claim 1, wherein the compliance evaluation routine is stored and processed at the compliance center or server.

8. The vehicle environmental compliance system of claim 1, wherein the triggering algorithm is stored and processed at the application or the compliance center or server, and wherein the triggering algorithm is applied before allowing obtain OBD data to be sent from the OBD tool.

9. The vehicle environmental compliance system of claim 1, wherein the triggering algorithm is stored and processed at the compliance center or server, and wherein the triggering algorithm is applied before allowing processed OBD data to be delivered to the compliance center or server.

10. The vehicle environmental compliance system of claim 1, wherein the triggering algorithm and the compliance evaluation routine are stored and processed at the compliance center or server, and wherein the triggering algorithm is applied before allowing the processed OBD data to be subjected to the compliance evaluation routine to form further processed OBD data.

11. The vehicle environmental compliance system of claim 1, wherein the triggering algorithm takes into account at least one factor selected from the group consisting of: duration from the previous compliance evaluation, mileage, make of automobile, year of automobile manufacturer, gas efficiency, sensed automobile parameter(s), and a randomly generated number.

12. The vehicle environmental compliance system of claim 1, wherein the application includes software for processing the OBD data or is a browser application that recalls software for processing the OBD data.

13. The vehicle environmental compliance system of claim 1, wherein the compliance center or server is configured to receive processed OBD data from multiple applications associated with multiple OBD tools.

14. A vehicle environmental compliance system comprising:
an onboard diagnostic (“OBD”) tool configured to obtain OBD data from a vehicle's onboard diagnostics;
an application for storage on a mobile computing device in communication with the OBD tool, the application configured to process the OBD data to form processed OBD data; and
a compliance center or server for receiving the processed OBD data from the application, the compliance center or server configured to subject the processed OBD data to a compliance evaluation routine, the compliance center or server maintaining a triggering algorithm that determines when the compliance evaluation routine is performed.

15. The vehicle environmental compliance system of claim 14, wherein the compliance center or server is configured to inform the application when to accept OBD data from the OBD tool based upon the triggering algorithm.

16. The vehicle environmental compliance system of claim 14, wherein the compliance center or server is configured to inform the application to accept OBD data from the OBD tool when the compliance evaluation routine is to be performed.

17. The vehicle environmental compliance system of claim 14, wherein the compliance center or server is configured accept to the processed OBD data when the compliance evaluation routine is to be performed.

18. A vehicle environmental compliance method comprising:
allowing a triggering algorithm stored on a computer memory and processed via a processor to trigger a compliance evaluation for a vehicle having onboard diagnostics;
upon triggering the compliance evaluation, electronically obtaining onboard diagnostic (“OBD”) data from an OBD tool, the OBD tool obtaining the OBD data from the vehicle's onboard diagnostics; and
electronically performing a compliance evaluation routine on the obtained OBD data or a derivative thereof.

19. The vehicle environmental compliance method of claim 18, which further includes transferring the OBD data or derivative thereof to a center or server for electronically performing the compliance evaluation routine, the transferring performed via an application that is portable so as to be brought into proximity of the OBD tool to obtain the OBD data.

20. The vehicle environmental compliance method of claim 19, wherein the center or server includes the computer memory storing the triggering algorithm.
